(19) United States
(12) Patent Application Publication
(10) Pub. No.: US 2026/0236424 A1
(43) Pub. Date: Aug. 13, 2026

(54) INTERCONNECT LINK MANAGEMENT AND OVERHEAD REDUCTION

(71) Applicant: QUALCOMM Incorporated, San Diego, CA (US)

(72) Inventors: Vishal MISHRA, San Diego, CA (US); Srivatsan THIRUVENGADAM, Carlsbad, CA (US); Ramacharan SUNDARARAMAN, San Jose, CA (US)

(21) Appl. No.: 19/048,576

(22) Filed: Feb. 7, 2025

(51) Int. Cl. G06F 13/42; H04L 1/1607; H04L 47/34

(52) U.S. Cl. CPC G06F 13/4282; H04L 1/1657; H04L 47/34

(57) ABSTRACT

Certain aspects of the disclosure relate to an integrated circuit (IC) device that includes multiple chiplets that are connected using a die-to-die (D2D) interconnect link. The interconnect link can use a protocol that enables transmission of acknowledgement or feedback information in a data-carrying transaction layer packet and a non-data-carrying transaction layer packet.

### TECHNICAL FIELD

The present disclosure relates generally to integrated circuit technology and more particularly to techniques for operating an interconnect link between dies or chiplets in a semiconductor device.

### BACKGROUND

A computer system can include a single or multiple integrated circuits with multiple cores or processors present on one or more individual integrated circuit devices or dies. An integrated circuit device can include one or more dies, which may include various components, for example, processing cores, neural processors, graphical processors, interfaces, memory, communication circuitry, etc. An integrated circuit device can be implemented using multiple integrated circuit dies that are included in the same package, and on-package interconnects can be used to connect the integrated circuit dies together. In some examples, an integrated circuit die can be referred to as a chiplet. A chiplet is a functional unit that performs certain specific tasks or provides certain functionality within an integrated circuit device containing multiple chiplets or dies.

An example of a die-to-die (D2D) interconnect link is the Universal Chiplet Interconnect Express (UCIe) link. UCIe is an open, multi-protocol capable, on-package interconnect standard for connecting multiple dies (e.g., chiplets) on the same integrated circuit (IC) package. A UCIe link can support multiple protocols (e.g., Peripheral Component Interconnect Express (PCIe), Compute Express Link (CXL), etc.) on top of a common physical and link layer. The UCIe link can provide interoperability across a wide range of devices having different performance characteristics and requirement. A UCIe link can provide various link widths, for example, 8 lanes (x8) and 16 lanes (x16). PCIe is another example of high speed interconnect standard that shares many similarities with UCIe.

### SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a form as a prelude to the more detailed description that is presented later.

Certain aspects of the disclosure relate to an integrated circuit (IC) device that include multiple chiplets or dies that are connected using a die-to-die (D2D) interconnect link.

One aspect of the disclosure provides an integrated circuit (IC) device including: a first chiplet and a second chiplet; and a die-to-die (D2D) interconnect link connected between the first chiplet and the second chiplet. The first chiplet is configured to send, to the second chiplet, a first transaction layer packet (TLP) including first data and a first sequence number associated with the first data. The second chiplet is configured to send, to the first chiplet, a second TLP that includes: the first sequence number and first acknowledgement information corresponding to the first data; and selective second data generated by the second chiplet.

One aspect of the disclosure provides a method for data communication using a die-to-die (D2D) interconnect link, including: sending, from a first chiplet to a second chiplet, a first transaction layer packet (TLP) including first data and a first sequence number associated with the first data; and sending, from the second chiplet to the first chiplet, a second TLP that includes: the first sequence number and first acknowledgement information corresponding to the first data; and selective second data generated by the second chiplet.

One aspect of the disclosure provides a system-on-chip (SoC), including: means for sending a first transaction layer packet (TLP) from a first chiplet to a second chiplet, the first TLP including first data and a first sequence number associated with the first data; and means for sending a second TLP from the second chiplet to the first chiplet, the second TLP includes: the first sequence number and first acknowledgement information corresponding to the first data; and selective second data generated by the second chiplet.

### BRIEF DESCRIPTION OF THE DRAWINGS

FIG. 1 illustrates an apparatus that can be implemented as an integrated circuit (IC) device including multiple components connected by interconnects according to some aspects of the disclosure.

FIG. 2 illustrates certain aspects of an apparatus that can be constructed using chiplets according to some aspects of the disclosure.

FIG. 3 illustrates an exemplary apparatus including multiple chiplets connected on a substrate according to some aspects of the disclosure.

FIG. 4 illustrates an exemplary protocol stack of a die-to-die (D2D) interconnect link according to some aspects of the disclosure.

FIG. 5 illustrates an exemplary data-carrying packet for a D2D interconnect link according to some aspects of the disclosure.

FIG. 6 illustrates an exemplary non-data-carrying packet for a D2D interconnect link according to some aspects of the disclosure.

FIG. 7 is a communication flow diagram illustrating a first process of D2D communication using data-carrying packets according to some aspects of the disclosure.

FIG. 8 is a communication flow diagram illustrating a second process of D2D communication using data-carrying packet and non-data-carrying packet according to some aspects of the disclosure.

FIG. 9 is a flow chart illustrating a method for operating a D2D interconnect link according to some aspects of the disclosure.

FIG. 10 is a flow chart illustrating a first process of receiving a packet according to some aspects of the disclosure.

FIG. 11 is a flow chart illustrating a second process of receiving a packet according to some aspects of the disclosure.

FIG. 12 is a flow chart illustrating a process of transmitting a packet according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the present disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

In the rapidly evolving field of semiconductor technology, the integration of multiple chiplets or dies within a single integrated circuit package represents a significant advancement towards achieving higher performance and scalability. The Universal Chiplet Interconnect Express (UCIe) is a die-to-die (D2D) interconnect link standard that facilitates the interconnectivity between diverse chiplets or dies to form a cohesive and functional integrated circuit (IC) device. D2D interconnections face significant challenges, including error-prone communication channels that require robust mechanisms to ensure data integrity. Cyclic redundancy check (CRC) has been used to mitigate bit errors. UCIe and modified Peripheral Component Interconnect Express (PCIe) protocols provide detailed definitions for link layer headers and methods for embedding CRC bits into transport layer packets. These frameworks aim to deliver reliable, high-performance communication between dies in chiplet-based systems while minimizing inefficiencies. However, this approach introduces notable overhead due to the inclusion of CRC bits and additional link layer management headers on top of transport layer data. Despite these advancements, the need for further innovation persists, particularly in reducing overhead and enhancing error correction in D2D connectivity.

The present disclosure provides various techniques to reduce overhead and latency in the transmission of acknowledgement information in a D2D interconnect link. Some aspects of the disclosure provide techniques for sending acknowledgement information for transaction layer packets (TLPs) by provisioning space for sending the acknowledgement information and the corresponding packet sequence number in the header of a TLP. The techniques enable a sender to receive acknowledgement information for previously sent data in the next transaction from the receiver. The techniques enable back-to-back data carrying packets from the transaction layer on devices on both ends of the D2D interconnect link. The techniques can reduce the use of non-data carrying packet traffic on the D2D interconnect link.

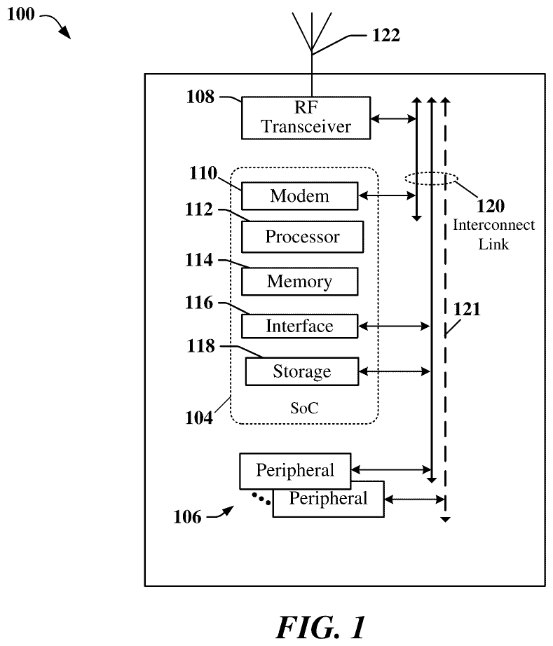

FIG. 1 illustrates an example of an apparatus 100 that can be implemented as an integrated circuit (IC) device including multiple components or dies (e.g., chiplets) that are connected by one or more interconnect links. In some examples, the apparatus 100 can be enclosed within a portable or a wearable device, such as a smartwatch or a mobile device (e.g., smartphone, mobile phone, notebook, tablet, etc.). In some aspects, the apparatus 100 includes various circuitry to perform different functions. In various examples, the circuitry can be implemented using one or more dies (e.g., chiplets) arranged in a configuration that can be adapted for use in mobile computing, embedded computing, edge computing, etc. In some aspects, the apparatus 100 may be configured to support multiple communication technologies, modes, and/or protocols. In some aspects, the apparatus 100 can include a system-on-chip (SoC) 104, one or more peripheral devices 106, and one or more transceivers 108 that cooperate to enable the apparatus to communicate through one or more antennas 122 with a radio access network (RAN), a core access network, the Internet, and/or another network. In some examples, the apparatus 100 can communicate with another device using a peer-to-peer (P2P) or device-to-device connection (e.g., Bluetooth, Wi-Fi, vehicle-to-vehicle (V2V) connection, or vehicle-to-everything (V2X) connection), or a mesh network.

In some aspects, the SoC 104 may include various circuitry, for example, one or more processors 112, one or more modems 110, one or more memories 114 (e.g., on-board memory), a communication interface circuit 116 (e.g., a bus interface), and/or other logic circuits or functions. The SoC can be controlled by an operating system that provides an application programming interface (API) layer that enables the one or more processors 112 to execute software modules or instructions residing in the one or more memories 114 and/or other processor-readable storage 118 provided on the SoC. The software modules may include instructions and data stored in the one or more memories 114 and/or processor-readable storage 118. The SoC 104 may access its one or more memories 114, the processor-readable storage 118, and/or storage external to the apparatus 100. The one or more memories 114 and the processor-readable storage 118 may include read-only memory (ROM), random-access memory (RAM), electrically erasable programmable ROM (EEPROM), flash memory, or any memory device that can be used in processing systems and computing platforms. The apparatus may include, implement, or have access to a local database or other parameter storage (e.g., tables, database, etc.) that can maintain operational parameters and other information used to configure and operate the apparatus 100 and/or the SoC 104. The local database may be implemented using registers, a database module, flash memory, magnetic media, EEPROM, soft or hard disk, or the like. The SoC 104 may also be coupled to external devices such as the antenna 122, a display, operator controls, switches or buttons, among other components.

The apparatus 100 can provide one or more interconnect links (e.g., interconnect link 120) that enables communication between different components (e.g., SoC 104, peripheral 106, and/or 108 radio frequency (RF) transceiver) that can be implemented in one or more dies (e.g., chiplets). In one example, the interconnect link 120 can include a Universal Chiplet Interconnect express (UCIe) link, a D2D interconnect link, or the like. In one example, the SoC 104 may include communication interface circuits 116 coupled to the interconnect. Each of the interface circuits 116 may include a combination of circuits, counters, timers, control logic and other configurable circuits or modules. In one example, certain interconnect interface circuits 116 may be configured to operate in accordance with standards-defined communication specifications or protocols, for example, UCIe, PCIe, etc. The apparatus 100 may include or control a power management function that configures and manages the operation of the apparatus 100.

In some aspects, the interconnect link 120 can use a protocol that enables transmission of acknowledgement or feedback information in data-carrying transaction layer packet (TLP) and non-data-carrying link layer packets. For example, the header of each link layer packet can include the receive (Rx) sequence number of an earlier received packet for which acknowledgement (ACK) or negative acknowledgement (NACK) is being sent in the current link layer packet (data-carrying or non-data-carrying).

In some aspects, the apparatus 100 may be included in mobile phones, tablet computers, palmtop computers, portable digital assistants (PDAs), portable game consoles, tablets, smartwatches, and other portable electronic devices. The various components and dies (e.g., chiplets) of the apparatus 100 may communicate with each other via one or more intra-chip communication interconnects. The apparatus 100 can be packaged in an integrated circuit (IC) package, which may be referred to as a “semiconductor package” or “chip package.” The IC package typically includes a package substrate and one or more IC chips, dies, chiplets, or other electronic modules mounted to the package substrate to provide electrical connectivity to the IC chips, dies, or chiplets. For example, an IC chip in an IC package may be configured as an SoC. The IC chips are electrically coupled to other IC chips and/or to other components in the IC package through electrical coupling to metal lines in the package substrate. The IC chips can also be electrically coupled to other circuits outside the IC package through electrical connections of external metal interconnects (e.g., solder bumps) of the IC package.

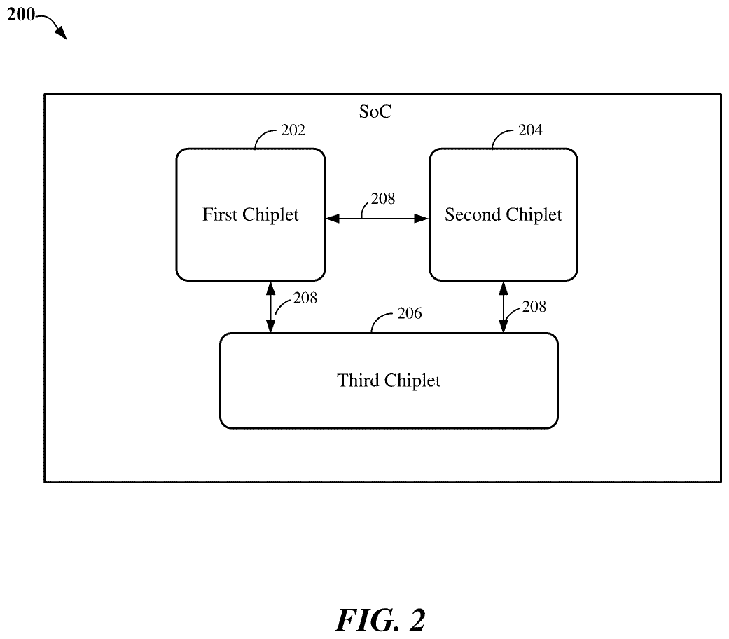

FIG. 2 is a block diagram illustrating certain aspects of a system-on-chip (SoC) 200 that can be constructed using chiplets according to some aspects. In some aspects, chiplet technology can be used to address some of the performance, power, and size design requirements for complex systems used in certain mobile or wearable devices. In one example, the SoC 200 may be the SoC 104 of FIG. 1 or any other SoC. The SoC 200 may be configured by selecting a combination of chiplets that implement certain subsystems or distinct functional elements. In the illustrated example, the SoC 200 may include multiple chiplets or dies, for example, a first chiplet 202, a second chiplet 204, and a third chiplet 206 that are connected to each other via one or more interconnect links 208. Each of the chiplets 202, 204, 206 can include a communication interface (e.g., communication interface circuit 116 of FIG. 1) connected to the corresponding interconnect link 208. In other examples, the SoC 200 may include fewer or more chiplets than those shown in FIG. 2. The chiplets can be configured to provide various subsystems or functions of the SoC 200. In some aspects, the interconnect link 208 can be a D2D interconnect link (e.g., UCIe link). In this example, two chiplets connected by a UCIe link can be referred as a UCIe module and a UCIe module partner (remote link partner), respectively. In other examples, the interconnect link 208 can be a PCIe link or the like. In some aspects, the interconnect link 208 can support various configurations in terms of the number of lanes, depending on the specific requirements and implementations of the devices involved. For example, the interconnect link 208 can have 8 lanes (x8), 16 lanes (x16), etc.

In some aspects, the SoC 200 may include a variety of processing engines, such as central processing units (CPUs) with multiple cores, graphical processing units (GPUs), digital signal processors (DSPs), neural processing units (NPUs), wireless transceiver units (also referred to as modems), peripherals, display and imaging interfaces, etc. Each of these subsystems and other functional elements can be implemented as an individual chiplet, or as a combination of chiplets (e.g., chiplets 202, 204, and/or 206). The chiplets included in the SoC 200 can be proprietary or may be acquired from a variety of sources. An SoC may be constructed from chiplets manufactured at different process nodes, operated at different voltages, and/or operated at different frequencies. In some aspects, the chiplets can be connected together using 3D or 2.5D chiplet technology. The term “2.5D” refers to a specific approach in semiconductor packaging technology, where multiple ICs (e.g., chiplets) are mounted onto an interposer that sits on top of a substrate. The interposer can be a piece of silicon that includes wiring and sometimes passive devices. The interposer serves as a bridge that connects the chiplets to each other and to the substrate.

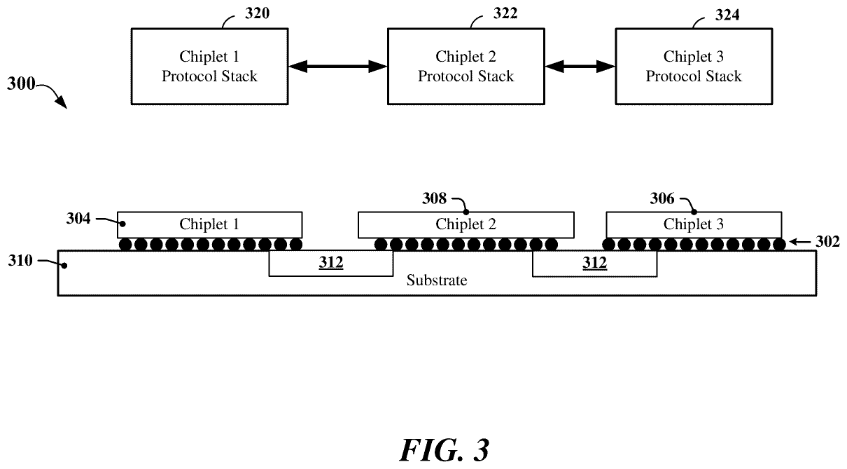

FIG. 3 illustrates an example of an SoC 300 including a plurality of chiplets according to some aspects of the disclosure. In one example, the SoC 300 includes a first chiplet 304, a second chiplet 306, and a third chiplet 308 on a substrate 310. In other examples, some chiplets can be placed in stacks that are deployed across the surface of the substrate 310, while other chiplets may be individually mounted on the surface of the substrate 310. In some aspects, chiplets may be mounted on the surface of the substrate using solder balls 302 (e.g., flip chip bumps) that provide electrical and/or thermal coupling between the substrate 310 and the mounted chiplets 304, 306, and 308. An interconnect structure 312 (e.g., a UCIe link) may be formed that enables the chiplets 304, 306, and/or 308 to communicate with one another, with other chiplets or circuitry mounted on the substrate 310, and with input/output structures that connect the SoC 300 with other circuits, displays, imaging sensors, communication interfaces, and other peripherals. In some examples, the SoC 300 may be any of the SoCs described above in FIGS. 1 and 2.

The use of chiplets can reduce the needed areal size of the substrate 310 and increase three-dimensional packing density. The constituent chiplets may provide complex features and high performance within a smaller form-factor operated at lower power specifications. In some aspects, the chiplet may define multiple power domains and operate at different frequencies. Different chiplets may manage power/frequency modes independently. In some instances, two or more chiplets may be operated in mutually exclusive power states. Additionally, operating conditions for an SoC may depend on the type, number, and arrangement of chiplets included on the substrate in addition to the modes of operation defined by applications. It is necessary to consider power usage by all chiplets in the SoC in order to ensure compliance with power budgets assigned for an application or device. A D2D interconnect link between chiplets or dies can use a layered protocol. One example of such protocol is the UCIe protocol. Hereafter, aspects of the present disclosure will be presented using a UCIe link and protocol. However, the present disclosure is not limited to the UCIe link and protocol. In other examples, aspects of the disclosure can be implemented using any suitable D2D interconnect links and protocols.

In some aspects, the chiplets 304, 306, and 308 can communicate with each other using corresponding protocol stacks 320, 322, and 324, for example, a UCIe protocol stack. For example, the UCIe protocol stack includes some or all of the following layers: a physical layer (PHY), a data link layer, a transaction layer, a protocol layer, and an application layer.

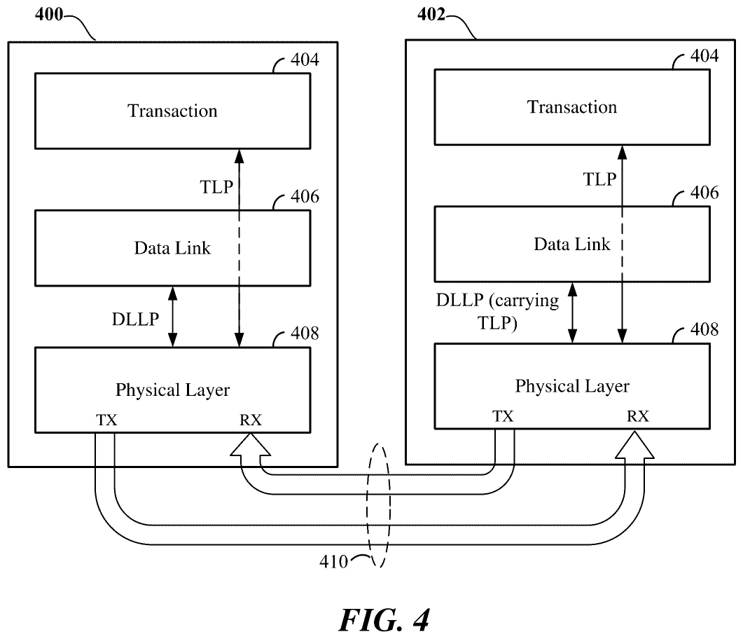

FIG. 4 illustrates exemplary protocol stacks of a D2D interconnect link according to some aspects of the disclosure. A first chiplet 400 can use a first protocol stack to communicate with a second chiplet 402 using a second protocol stack. Each protocol stack can include a transaction layer 404, a data link layer 406, and a physical (PHY) layer 408. In some aspects, there can be additional layers (e.g., application layer, protocol layer) above the transaction layer. In one example, the D2D interconnect link may be a UCIe link.

The transaction layer creates transaction layer packets (TLPs) for transmission across the UCIe link 410. Each TLP can include a header, payload, and metadata (e.g., CRC) used for error detection and replay. The transaction layer can manage different types of operations such as memory reads, writes, and I/O requests. The transaction layer ensures that responses to requests (e.g., acknowledgment or data delivery) are properly formatted and transmitted. The transaction layer sends the TLP to the data link layer which adds a data link layer header and cyclic redundancy check (CRC) to the TLP. TLP is a packet originating at the transaction layer of one chiplet (e.g., first chiplet 400) and ending at the transaction layer of the other chiplet (e.g., second chiplet 402). DLLP is a packet that originates at the data link layer of one chiplet (e.g., first chiplet 400) and ends at the data link layer of the other chiplet (e.g., second chiplet 402). The DLLP is not exposed beyond the data link layer and the transaction layer is unaware of the DLLP generation, transmission, and reception. TLP on the other hand is visible to the transaction layer. The data link layer is responsible for ensuring reliable communication between the chiplets by maintaining the integrity of transmitted packets. The DLLP is sent over the UCIe link 410 via the physical layer 408 and received by the other device. The data link layer of the receiver decodes the DLLP (if received) to extract the TLP which is then sent to the transaction layer.

In UCIe or similar protocols (e.g., PCIe), acknowledgement feedback (ACK and NACK) is the mechanism used in the data link layer to ensure reliable transmission of packets across the link. When a sender (e.g., a first chiplet) transmits a packet, it awaits acknowledgment from the receiver (e.g., a second chiplet). The receiver checks the integrity of the received packet (e.g., CRC). If the packet is error-free, the receiver sends an ACK back to the sender. Therefore, the sender knows the packet was successfully delivered and can proceed with sending the next packet. The NACK is used to inform the sender that a packet was received with errors and needs to be retransmitted. When the receiver detects an error in a received packet (e.g., a CRC mismatch), instead of sending an ACK, the receiver sends a NACK to the sender. Upon receiving the NACK, the sender can retransmit the packet. In some aspects, the ACK/NACK can be included in a DLLP which does not carry user data from a higher protocol layer (e.g., transaction layer).

In some aspects, the sender processes data at the transaction layer 404 and appends a sequence number, header, and CRC bits to a form a TLP. The sender may also create a copy of the TLP in a replay buffer for a later replay or retransmission (if needed). In one example, the buffer can be in the memory 114 and/or storage 118 of FIG. 1. The size of the replay buffer can be sized (e.g., TLP size x depth) to account for round trip latency of the UCIe link. Then the sender can send the TLP to the receiver through the UCIe protocol stack (e.g., via the data link layer and physical layer). If the sender receives an ACK for the sequence number from the receiver, then the sender can remove the TLP entry in the replay buffer. If the sender receives an NACK for the sequence number, then the sender can read the TLP from the reply buffer and retransmit it to the receiver.

The UCIe protocol can arbitrate traffic through the link using a certain arbitration priority. For example, highest priority can be given to completion of any transmission in progress (TLP or DLLP transmission). For example, the priority order can be given to the following transmissions from higher to lower priority: NACK DLLP transmissions, ACK DLLP transmissions, flow control DLLP transmissions, packet re-transmissions, TLPs from the transaction layer, and all other DLLP Transmissions.

However, there are inefficiencies caused by the use of DLLPs for sending ACK and NACK of TLPs. During the transmission of a DLLP, no actual payload data (e.g., user or application data from above the data link layer) is being transferred. This results in inefficiency, as bandwidth is consumed for link management rather than productive data transfer. Further, the process of sending and receiving DLLPs can incur power overhead at both the transmitter and receiver, impacting overall system energy efficiency. Even when an ACK DLLP is sent, the replay buffer needs to keep the TLP copy while waiting for the acknowledgment before the TLP copy can be removed, increasing the needed size of the buffer. Furthermore, sending a DLLP can block the transaction layer traffic, delaying the transmission of new TLPs.

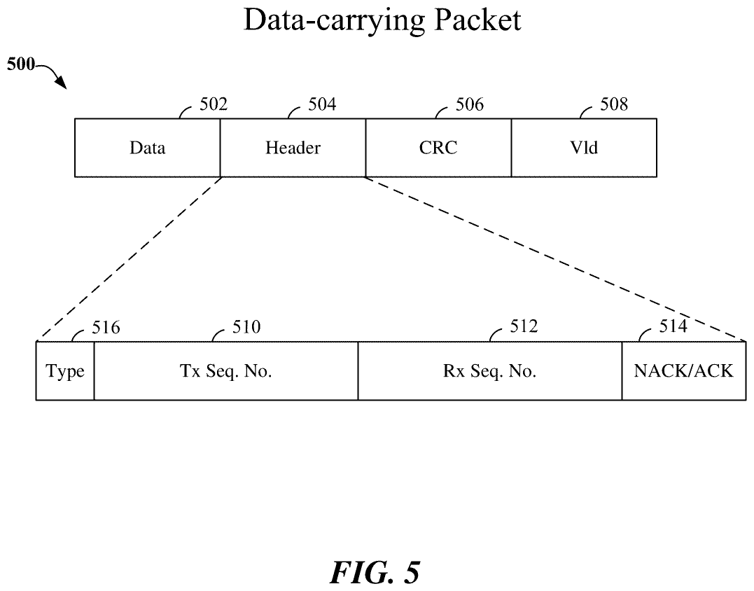

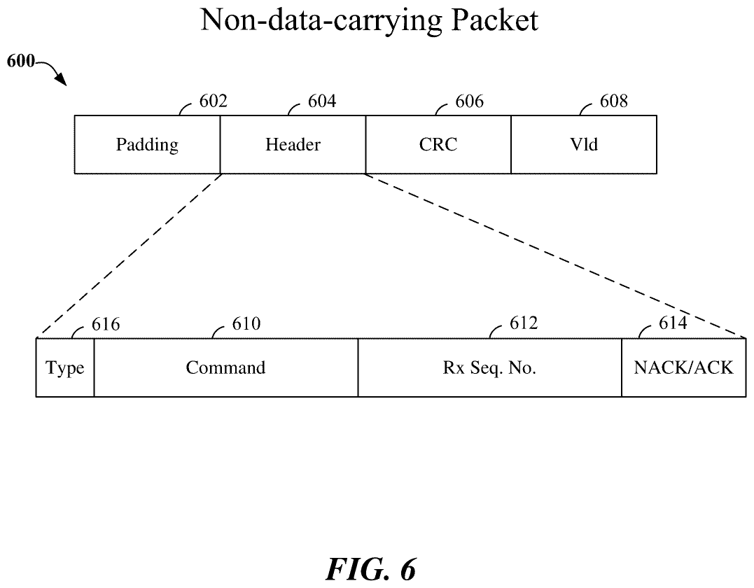

FIGS. 5 and 6 are diagrams illustrating exemplary packet formats for a D2D interconnect link according to some aspects of the disclosure. The packet formats enable techniques for reducing the overhead of sending acknowledgement information (e.g., ACK/NACK for TLPs) over a D2D interconnect link, for example, a UCIe link or the like. In some aspects, the acknowledgement information can be ACK/NACK for the previously sent TLP. In some aspects, there are two types of packets that the data link layer can send through the PHY layer. The first type is the data-carrying packet 500 of FIG. 5 that is similar to TLP for sending transaction layer data. The second type is the non-data-carrying packet 600 of FIG. 6 that is used for functions (e.g., flow control, link management, etc.) similar to DLLP.

Referring to FIG. 5, the data-carrying packet 500 includes a data field 502, a header 504, a CRC field 506, and a valid field (Vld) 508. The data field 502 carries the payload of the data-carrying packet. For example, the data field can carry the actual information (e.g., user or application layer data) being transmitted between chiplets, such as instructions, data for processing, or responses to requests. The size of the data field 502 may vary depending on the specific transaction. The header 504 can contain various metadata about the packet, for example, a sequence number used for in-order delivery and retransmission of packets. The CRC field 506 contains a checksum calculated over the entire packet (e.g., header and data). The receiver can use the CRC to detect errors that may have occurred during transmission. If the calculated CRC at the receiver does not match the transmitted CRC, it indicates data corruption and may trigger retransmission of the packet. The valid field 508 can indicate whether the packet contains valid data or not. For example, when the valid field is set to a first value (e.g., “1”), it can signify that the current packet is valid and contains meaningful data (e.g., user data) that should be processed by the receiving chiplet or die. When the valid field is set to a second value (e.g., “0”), it can indicate that the packet does not carry valid data and can be ignored. In this case, padding data (e.g., “0” bits) can be used to fill the data field 502.

In some aspects, the header 504 of the data-carrying packet can contain a Tx sequence number 510 and a Rx sequence number 512. The Tx sequence number indicates the sequence number of the data (e.g., TLP packet) being sent by in the current data-carrying packet. The Rx sequence number indicates the sequence number of an earlier received packet for which acknowledgement 514 (e.g., ACK or NACK) is being sent in the current data-carrying packet. The header 504 may also include a packet type field 516 to identify that the packet is a data-carrying packet or non-data-carrying packet. For example, the packet type field 516 can be set to “1” to indicate a data-carrying packet as described above in FIG. 5. The packet type field 516 can be set to “0” to indicate a non-data-carrying packet that will be described in more detail below in relation with FIG. 6.

Referring to FIG. 6, a non-data-carrying packet 600 includes a padding field 602, a header 604, a CRC field 606, and a valid field (Vld) 608. The functions of these fields are similar to those of the data-carrying packet 500 described above and only their differences are discussed for the purpose of brevity. The padding field 602 can carry one or more padding data (e.g., “0” bits) because the non-data-carrying packet 600 does not carry transaction layer data (e.g., TLP).

In some aspects, the header 604 of the non-data-carrying packet can contain a command field 610 and a Rx sequence number 612. The Rx sequence number indicates the sequence number of an earlier received packet for which acknowledgement 614 (e.g., ACK or NACK) is being sent in the current non-data-carrying packet. The header 604 may also include a packet type field 616 to identify that the packet is a data-carrying packet or non-data-carrying packet. For example, the packet type field 616 can be set to “0” to indicate a non-data-carrying packet. The command field 610 can indicate the type of non-data-carrying packet, for example, acknowledgement, power management, link state management, etc. The Rx sequence number is relevant when the command field indicates that the packet is an acknowledgement type.

The above-described data-carrying packet 500 and non-data-carrying packet 600 provide a mechanism to transmit the Rx sequence number and ACK/NACK indication for TLPs without using non-data carrying DLLPs. In effect, the sender can append or piggyback an ACK/NACK DLLP to an ongoing TLP (e.g., the data-carrying packet 500). If there is no ongoing traffic or no data from the transaction layer in the current clock cycle or transaction, the receiver can send a standalone non-data-carrying packet including the ACK/NACK DLLP (if needed). However, if there is a valid transaction from the transaction layer, the ACK/NACK information can be appended directly to the data-carrying packet, instead of sending a separate non-data-carrying DLLP.

In some aspects, to optimize the number of bits in the header, no separate bit is used to indicate whether the ACK/NACK field is valid within the header. In one example, the sequence number “0” is reserved (not used) so that the receiver can ignore the ACK/NACK bit and Rx sequence number when the RX sequence number is 0. While this approach reduces the effective depth of the replay buffer by one, it can streamline the decode process of the packet. In another example, the device can ignore the ACK/NACK field and Rx sequence number when the Rx sequence number is 0, but in this case, the device sends a specific non-data-carrying packet containing ACK/NACK for sequence number 0. These approaches aim to optimize efficiency without adding extra bits to the header.

The above-described data packet formats eliminate the need to use separate non-data-carrying packets (e.g., DLLPs) for send acknowledgement information (e.g., ACK/NACK DLLP), because the acknowledgement can be integrated with transaction layer data packets (e.g., TLPs). This ensures ACK/NACK for sent data can be received within the next transaction from the receiver, reducing the need of large replay buffer on the transmitter side. Additionally, these packet formats enable back-to-back packet transmissions (consecutive in sequence) between the transaction layers on both the transmitter and receiver sides, avoiding transmission gaps caused by standalone non-data carrying ACK/NACK DLLPs. The packet formats of packets 500 and 600 can improve the effective bandwidth of the D2D communication while reducing non-data packet traffic on the D2D interconnect link, leading to better overall efficiency, lower power consumption, and improved end-to-end latency for the D2D link.

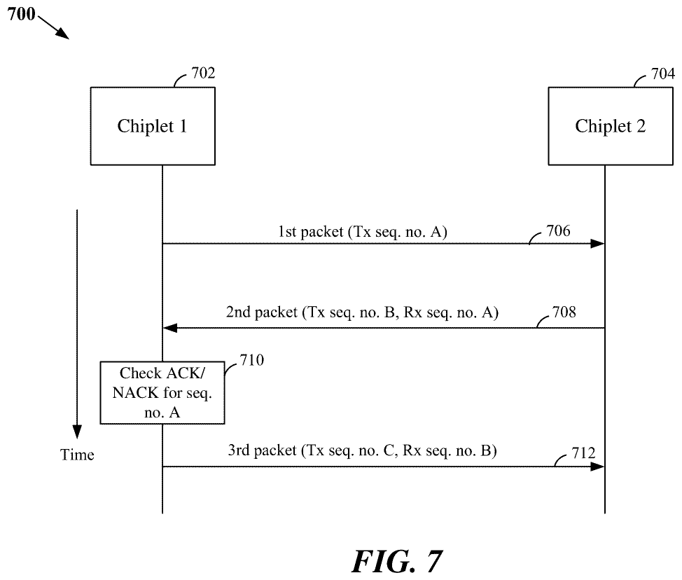

FIG. 7 is a communication flow diagram 700 illustrating a process of D2D communication using the packet formats described above in accordance with some aspects. For example, a first chiplet 702 and a second chiplet 704 can communicate with each other using a D2D interconnect link (e.g., UCIe link). When the first chiplet 702 has transaction layer data (e.g., TLP) for transmission to the second chiplet 704, the first chiplet 702 can send a first packet 706 to the second chiplet. In some aspects, the first packet can have a format like the data-carrying packet 500 of FIG. 5. The first packet can contain the Tx sequence number A of first data included in the packet.

After receiving the first packet, if the second chiplet has data for transmission to the first chiplet, the second chiplet can send a second packet 708 (e.g., TLP) to the first chiplet. The second packet can contain the Tx sequence number B of the second data and the Rx sequence number A corresponding to the received first data. The second packet can also contain the acknowledgement information (ACK/NACK) for packet sequence number A.

After receiving the second packet, the first chiplet 702 can check the acknowledgement information to determine whether or not the second chiplet successfully received the first data in the first packet with the sequence number A. If the acknowledgement information contains ACK for sequence number A, the second chiplet 704 successfully received the first data, and the first chiplet 702 does not need to resend the first data.

Then, the first chiplet can send another packet to the second chiplet. For example, the first chiplet can send a third packet 712 to the second chiplet. The third packet can contain the Tx sequence number C of the third data and the Rx sequence number B corresponding to the second data. After receiving the third packet, the second chiplet 704 can check the acknowledgement information to determine whether or not the first chiplet successfully received the second data with the sequence number B. In the above example, the first chiplet and the second chiplet can send acknowledgement information to each other in back-to-back (consecutive in sequence) data-carrying packet transmissions without the need to use ACK/NACK DLLP.

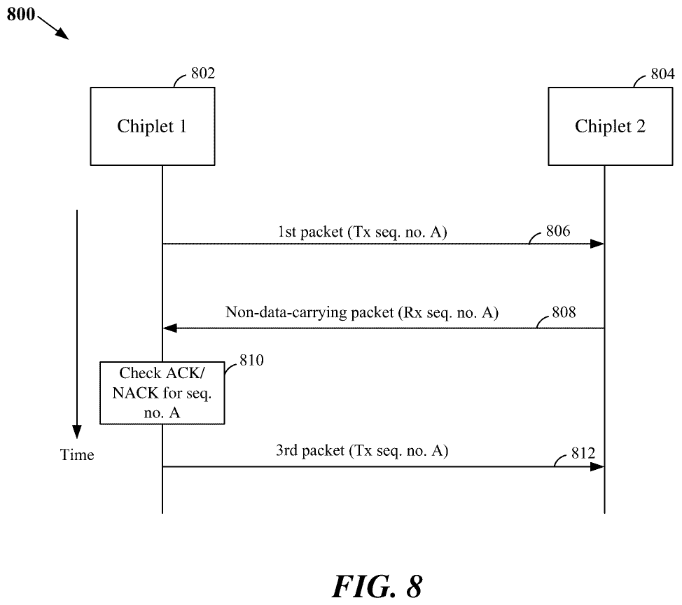

FIG. 8 is a communication flow diagram 800 illustrating a process of D2D communication using the packet formats described above in accordance with some aspects. For example, a first chiplet 802 and a second chiplet 804 can communicate with each other using a D2D interconnect link (e.g., UCIe link). When the first chiplet 802 has transaction layer data (e.g., TLP) for transmission to the second chiplet 804, the first chiplet 802 can send a first packet 806 to the second chiplet. In some aspects, the first packet can have a format like the data-carrying packet 500 of FIG. 5. The first packet can contain the Tx sequence number A of the first data contained in the first packet.

After receiving the first packet, if the second chiplet 804 has no data for transmission to the first chiplet, the second chiplet can send a non-data-carrying packet 808 to the first chiplet. For example, the non-data-carrying packet can have a format like the non-data-carrying packet 600 of FIG. 6. The non-data-carrying packet can contain a command field (command 610 of FIG. 6) encoded to indicate that the non-data-carrying packet includes the acknowledgement information of the first data. In this example, the non-data-carrying packet contains the Rx sequence number A corresponding to the first data of the first packet 806.

After receiving the non-data-carrying packet 808, the first chiplet 802 can check the acknowledgement information to determine whether or not the second chiplet successfully received the first data with the sequence number A. If the acknowledgement information contains ACK for sequence number A, the second chiplet 804 successfully received the first data, and the first chiplet 802 does not need to resend the first data. If the acknowledgement information contains NACK for sequence number A, the second chiplet 804 does not successfully receive the first data, and the first chiplet 802 can resend the first data in a third packet 812 to the second chiplet. The third packet can contain the Tx sequence number A of the first data. In the above example, the second chiplet can send TLP acknowledgement information to the first chiplet without using non-data carrying DLLP when the second chiplet has no data to send.

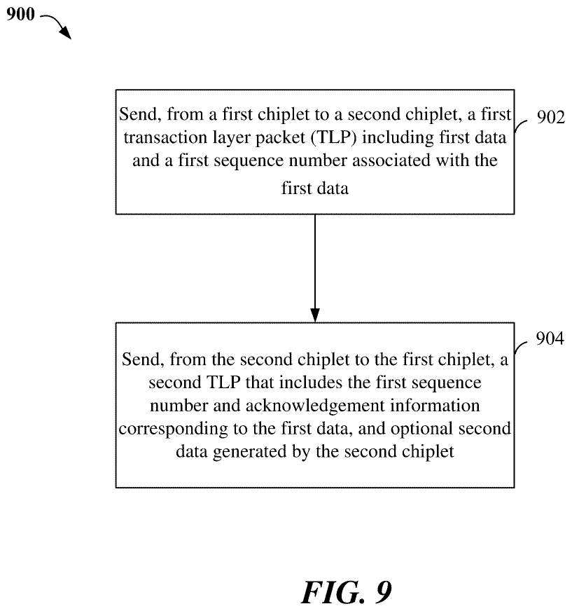

FIG. 9 is a flow chart illustrating a method 900 for operating a D2D interconnect link according to some aspects of the disclosure. For example, the method 900 can be used by an apparatus (e.g., a chiplet) to operate a UCIe link between chiplets described above in relation to FIGS. 1-8. In one example, the D2D interconnect link can use a UCIe link described above in relation to FIGS. 1-8 or any D2D interconnect link.

At 902, the method can send, from a first chiplet to a second chiplet, a first TLP including first data and a first sequence number associated with the first data. The first TLP can be a data-carrying packet like the data-carrying packet 500 of FIG. 5. For example, the first data can be transaction layer data or higher layer data (e.g., application data). The first sequence number can be a sequence number of the first TLP that indicates a transmission order of the first TLP among a plurality of packets. In one example, the processor 112 and/or interface 116 of FIG. 1 can provide a means to send the first packet.

At 904, the method can send, from the second chiplet to the first chiplet, a second TLP that includes the first sequence number and acknowledgement information corresponding to the first data. The second TLP can include selective second data generated by the second chiplet. For example, the second TLP can include the selective second data when the second chiplet has transaction layer data destined to the first chiplet.

In some aspects, the second TLP can include a type field that is configured to indicate a packet type of the second TLP among a data-carrying type and a non-data-carrying type. For example, the data-carrying type can be the data-carrying packet 500 of FIG. 5, and the non-data-carrying type can be the non-data-carrying packet 600 of FIG. 6. In some cases, the data-carrying type is used for sending TLPs, and the non-data-carrying type can be used for sending DLLPs. In one example, the processor 112 and/or interface 116 of FIG. 1 can provide a means to receive the second transaction layer packet.

In one configuration, the apparatus 100 includes the various means for performing the processes and techniques described above in FIG. 9. The aforementioned means may be the processor(s) 112 in which the invention resides shown in FIG. 1 configured to perform the functions recited by the aforementioned means. In another aspect, the aforementioned means may be a circuit or any apparatus configured to perform the functions recited by the aforementioned means.

Of course, in the above examples, the processor 112 is merely provided as an example, and other means for carrying out the described functions may be included within various aspects of the present disclosure, including but not limited to the instructions stored in a computer-readable storage medium (e.g., storage 118 of FIG. 1), or any other suitable apparatus or means described in any one of the FIGS. 1-8, and utilizing, for example, the processes and/or algorithms described herein in relation to FIGS. 1-9.

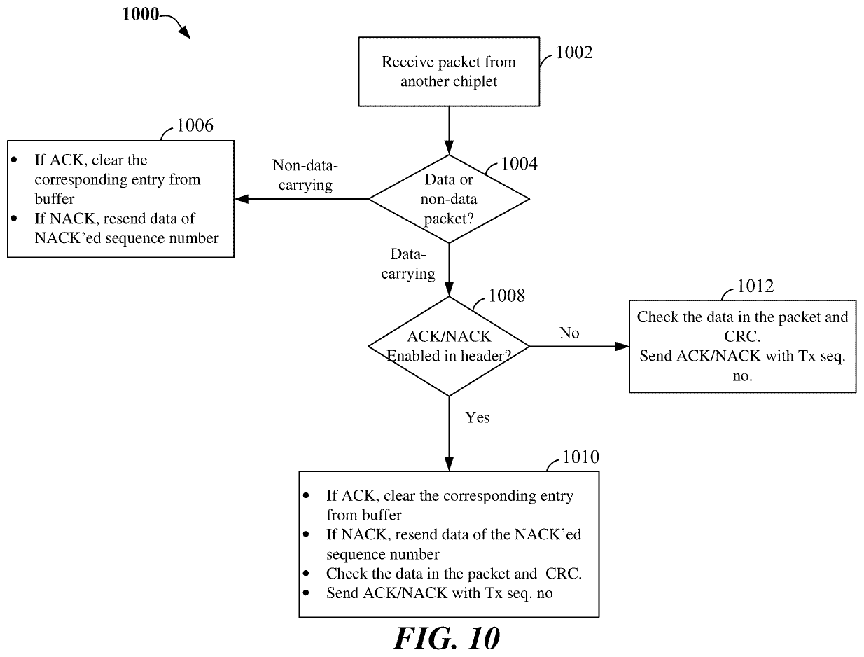

FIG. 10 is a flow chart illustrating a first process 1000 of receiving a packet according to some aspects of the disclosure. For example, the process 1000 can be used by a first chiplet that is connected to a second chiplet by a UCIe link as described above in relation to FIGS. 1-8. The UCIe link can be in an idle state when the chiplets are not receiving or sending packets.

At 1002, a first chiplet can receive a data packet from a second chiplet. At 1004, the chiplet can determine whether the data packet is a data-carrying packet (e.g., data-carrying package 500 of FIG. 5) or a non-data-carrying packet (e.g., non-data-carrying packet 600 of FIG. 6). The data-carrying packet or non-data-carrying packet can be a packet that originates from a transaction layer of the chiplet.

At 1006, if the received data packet is a non-data-carrying packet, the chiplet can decode the command (e.g., command 610 of FIG. 6) in the header of the packet to determine if the packet carries acknowledgement information (e.g., ACK/NACK) for a data-carrying packet previously transmitted by the first chiplet. If the packet contains an ACK, the first chiplet can clear the entry for the ACK'ed data in the replay buffer. If the packet contains an NACK, the first chiplet can resend the data of the NACK'ed packet with the same sequence number.

At 1008, for a data-carrying packet, the first chiplet can determine whether or not the packet contains acknowledgement information and a non-zero Rx sequence number. For example, the header of the data-carrying packet can contain the Rx sequence number and corresponding ACK/NACK. A non-zero Rx sequence number indicates the sequence number of an earlier received packet for which ACK/NACK is provided in the current data-carrying packet. If the Rx sequence number is zero, the first chiplet can ignore the acknowledgement information.

At 1010, if the received packet contains an ACK and a non-zero Rx sequence number, the first chiplet can clear the corresponding entry in the reply buffer. If the received packet contains an NACK, the chiplet can resend the data corresponding to the Rx sequence. Further, the first chiplet can check the received data and CRC contained in the data-carrying packet. Then, the first chiplet can send ACK/NACK with the Tx sequence no. of the received data.

At 1012, if the received packet does not contain acknowledgement information (e.g., ACK or NACK), the first chiplet can check the received data and CRC contained in the data-carrying packet. Then, the first chiplet can send ACK/NACK with the Tx sequence no. of the received data.

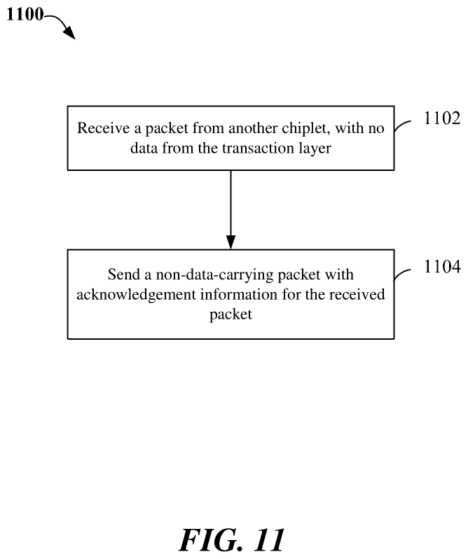

FIG. 11 is a flow chart illustrating a second process 1100 of receiving a packet according to some aspects of the disclosure. For example, the process 1100 can be performed at a first chiplet that is connected to a second chiplet by a UCIe link as described above in relation to FIGS. 1-8. The UCIe link can be in an idle state when the chiplets are not receiving or sending packets.

At 1102, the first chiplet can receive a packet from the second chiplet, while the first chiplet receives no data from its transaction layer. For example, the packet can be a packet (e.g., data-carry packet 500 of FIG. 5) that carries data sent by the second chiplet. The data can originate from the transaction layer of the second chiplet. At 1104, the first chiplet can send a non-data-carrying packet (e.g., non-data-carrying packet 600 of FIG. 6) with acknowledgement information (e.g., ACK/NACK) and sequence number for the data received from the second chiplet. In some cases, the first chiplet can send a DLLP with the ACK/NACK status of the data.

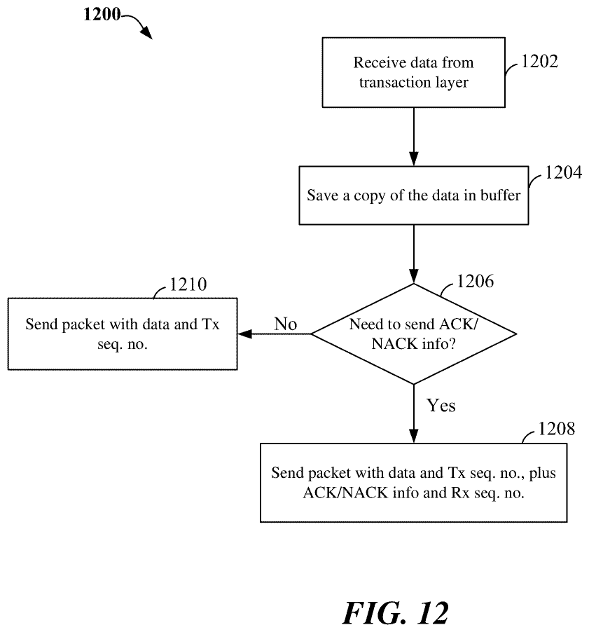

FIG. 12 is a flow chart illustrating a process 1200 of transmitting a packet according to some aspects of the disclosure. For example, the process 1200 can be performed at a first chiplet that is connected to a second chiplet by a UCIe link as described above in relation to FIGS. 1-8. The UCIe link can be in an idle state when the chiplets are not receiving or sending packets.

At 1202, the first chiplet can receive data from its transaction layer. The transaction layer data can be destined to a transaction layer of the second chiplet. At 1204, the first chiplet can save a copy of the received data in a reply buffer such that the first chiplet can resend the data if necessary. For example, the reply buffer can be kept in the memory 114 and/or storage 118 of FIG. 1. At 1206, the first chiplet can determine if it needs to provide acknowledgement information (e.g., ACK or NACK) for data (e.g., data contained in a TLP) previously received from the second chiplet.

At 1208, the first chiplet can send a data-carrying packet including the acknowledgement information to the second chiplet. The data-carrying packet (e.g., data-carrying packet 500 of FIG. 5) can include the data received from the transaction layer, a Tx sequence number for the data, plus ACK/NACK and Rx sequence number for the data received from the second chiplet.

At 1210, the first chiplet can send a data-carrying packet to the second chiplet without including any acknowledgement information. In this case, the data-carry packet includes the data received from the first chiplet's transaction layer, without the need to provide acknowledgement information for data previously received from the second chiplet. In some aspects, the first chiplet can send a regular TLP packet.

Some implementation examples are described in the following numbered clauses:

Aspect 1: An integrated circuit (IC) device comprising: a first chiplet and a second chiplet; and a die-to-die (D2D) interconnect link connected between the first chiplet and the second chiplet, wherein the first chiplet is configured to send, to the second chiplet, a first transaction layer packet (TLP) comprising first data and a first sequence number associated with the first data; and wherein the second chiplet is configured to send, to the first chiplet, a second TLP that comprises: the first sequence number and first acknowledgement information corresponding to the first data; and selective second data generated by the second chiplet.

Aspect 2: The IC device of aspect 1, wherein the first chiplet is further configured to: determine that the first data is successfully transmitted in response to the first acknowledgement information being an acknowledgement (ACK) of the first data; and determine that the first data is not successfully transmitted in response to the first acknowledgement information being a negative acknowledgement (NACK) of the first data.

Aspect 3: The IC device of aspect 1 or 2, wherein the first chiplet is further configured to: send, to the second chiplet, a third TLP comprising the first data in response to the first acknowledgement information being a negative acknowledgement (NACK) of the first data.

Aspect 4: The IC device of aspect 1 or 2, wherein the second TLP comprises: a type field configured to indicate that the second TLP is a data-carrying type packet; and a second sequence number associated with the second data.

Aspect 5: The IC device of aspect 4, wherein the first TLP and the second TLP are consecutive in sequence number.

Aspect 6: The IC device of aspect 1 or 2, wherein the second TLP comprises: a type field configured to indicate that the second TLP is a non-data-carrying type packet; and a command configured to indicate a type of the second TLP among acknowledgement, power management, and link state management.

Aspect 7: The IC device of aspect 1 or 2, wherein the first TLP comprises the first data, the first sequence number, and acknowledgement information corresponding to a third TLP previously received by the first chiplet.

Aspect 8: The IC device of aspect 1 or 2, wherein the first chiplet is further configured to: send, to the second chiplet, a data link layer packet comprising acknowledgement information and sequence number corresponding to a TLP previously received from the second chiplet, in response to receiving no data destined to the second chiplet from a transaction layer of the first chiplet.

Aspect 9: The IC device of aspect 1 or 2, wherein the first chiplet is further configured to: determine whether to include second acknowledgement information in the first TLP for a previously received TLP from the second chiplet; and conditionally include the second acknowledgement information in the first TLP based on the determination.

Aspect 10: A method for data communication using a die-to-die (D2D) interconnect link, comprising: sending, from a first chiplet to a second chiplet, a first transaction layer packet (TLP) comprising first data and a first sequence number associated with the first data; and sending, from the second chiplet to the first chiplet, a second TLP that comprises: the first sequence number and first acknowledgement information corresponding to the first data; and selective second data generated by the second chiplet.

Aspect 11: The method of aspect 10, further comprising: determining that the first data is successfully transmitted in response to the first acknowledgement information being an acknowledgement (ACK) of the first data; and determining that the first data is not successfully transmitted in response to the first acknowledgement information being a negative acknowledgement (NACK) of the first data.

Aspect 12: The method of aspect 10 or 11, further comprising: sending, from the first chiplet to the second chiplet, a third TLP comprising the first data in response to the first acknowledgement information being a negative acknowledgement (NACK) of the first data.

Aspect 13: The method of aspect 10 or 11, wherein the second TLP comprises: a type field configured to indicate that the second TLP is a data-carrying type packet; and a second sequence number associated with the second data.

Aspect 14: The method of aspect 13, wherein the first TLP and the second TLP are consecutive in sequence number.

Aspect 15: The method of aspect 10 or 11, wherein the second TLP comprises: a type field configured to indicate that the second TLP is a non-data-carrying type packet; and a command configured to indicate a type of the second TLP among acknowledgement, power management, and link state management.

Aspect 16: The method of aspect 10 or 11, wherein the first TLP comprises the first data, the first sequence number, and acknowledgement information corresponding to a third TLP previously received by the first chiplet.

Aspect 17: The method of aspect 10 or 11, further comprising: sending, from the first chiplet to the second chiplet, a data link layer packet comprising acknowledgement information and sequence number corresponding to a TLP previously received from the second chiplet, in response to receiving no data destined to the second chiplet from a transaction layer of the first chiplet.

Aspect 18: The method of aspect 10 or 11, further comprising: determining whether to include second acknowledgement information in the first TLP for a previously received TLP from the second chiplet; and conditionally including the second acknowledgement information in the first TLP based on the determination.

Aspect 19: A system-on-chip (SoC), comprising: means for sending a first transaction layer packet (TLP) from a first chiplet to a second chiplet, the first TLP comprising first data and a first sequence number associated with the first data; and means for sending a second TLP from the second chiplet to the first chiplet, the second TLP comprises: the first sequence number and first acknowledgement information corresponding to the first data; and selective second data generated by the second chiplet.

Aspect 20: The SoC of aspect 19, further comprising: means for determining that the first data is successfully transmitted in response to the first acknowledgement information being an acknowledgement (ACK) of the first data; and means for determining that the first data is not successfully transmitted in response to the first acknowledgement information being a negative acknowledgement (NACK) of the first data.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

What is claimed is:

1. An integrated circuit (IC) device comprising:
a first chiplet and a second chiplet; and
a die-to-die (D2D) interconnect link connected between the first chiplet and the second chiplet,
wherein the first chiplet is configured to send, to the second chiplet, a first transaction layer packet (TLP) comprising first data and a first sequence number associated with the first data; and
wherein the second chiplet is configured to send, to the first chiplet, a second TLP that comprises:
the first sequence number and first acknowledgement information corresponding to the first data; and
selective second data generated by the second chiplet.

2. The IC device of claim 1, wherein the first chiplet is further configured to:
determine that the first data is successfully transmitted in response to the first acknowledgement information being an acknowledgement (ACK) of the first data; and
determine that the first data is not successfully transmitted in response to the first acknowledgement information being a negative acknowledgement (NACK) of the first data.

3. The IC device of claim 1, wherein the first chiplet is further configured to:
send, to the second chiplet, a third TLP comprising the first data in response to the first acknowledgement information being a negative acknowledgement (NACK) of the first data.

4. The IC device of claim 1, wherein the second TLP comprises:
a type field configured to indicate that the second TLP is a data-carrying type packet; and
a second sequence number associated with the second data.

5. The IC device of claim 4, wherein the first TLP and the second TLP are consecutive in sequence number.

6. The IC device of claim 1, wherein the second TLP comprises:
a type field configured to indicate that the second TLP is a non-data-carrying type packet; and
a command configured to indicate a type of the second TLP among acknowledgement, power management, and link state management.

7. The IC device of claim 1, wherein the first TLP comprises the first data, the first sequence number, and acknowledgement information corresponding to a third TLP previously received by the first chiplet.

8. The IC device of claim 1, wherein the first chiplet is further configured to:
send, to the second chiplet, a data link layer packet comprising acknowledgement information and sequence number corresponding to a TLP previously received from the second chiplet, in response to receiving no data destined to the second chiplet from a transaction layer of the first chiplet.

9. The IC device of claim 1, wherein the first chiplet is further configured to:
determine whether to include second acknowledgement information in the first TLP for a previously received TLP from the second chiplet; and
conditionally include the second acknowledgement information in the first TLP based on the determination.

10. A method for data communication using a die-to-die (D2D) interconnect link, comprising:
sending, from a first chiplet to a second chiplet, a first transaction layer packet (TLP) comprising first data and a first sequence number associated with the first data; and
sending, from the second chiplet to the first chiplet, a second TLP that comprises:
the first sequence number and first acknowledgement information corresponding to the first data; and
selective second data generated by the second chiplet.

11. The method of claim 10, further comprising:
determining that the first data is successfully transmitted in response to the first acknowledgement information being an acknowledgement (ACK) of the first data; and
determining that the first data is not successfully transmitted in response to the first acknowledgement information being a negative acknowledgement (NACK) of the first data.

12. The method of claim 10, further comprising:
sending, from the first chiplet to the second chiplet, a third TLP comprising the first data in response to the first acknowledgement information being a negative acknowledgement (NACK) of the first data.

13. The method of claim 10, wherein the second TLP comprises:
a type field configured to indicate that the second TLP is a data-carrying type packet; and
a second sequence number associated with the second data.

14. The method of claim 13, wherein the first TLP and the second TLP are consecutive in sequence number.

15. The method of claim 10, wherein the second TLP comprises:
a type field configured to indicate that the second TLP is a non-data-carrying type packet; and
a command configured to indicate a type of the second TLP among acknowledgement, power management, and link state management.

16. The method of claim 10, wherein the first TLP comprises the first data, the first sequence number, and acknowledgement information corresponding to a third TLP previously received by the first chiplet.

17. The method of claim 10, further comprising:
sending, from the first chiplet to the second chiplet, a data link layer packet comprising acknowledgement information and sequence number corresponding to a TLP previously received from the second chiplet, in response to receiving no data destined to the second chiplet from a transaction layer of the first chiplet.

18. The method of claim 10, further comprising:
determining whether to include second acknowledgement information in the first TLP for a previously received TLP from the second chiplet; and
conditionally including the second acknowledgement information in the first TLP based on the determination.

19. A system-on-chip (SoC), comprising:
means for sending a first transaction layer packet (TLP) from a first chiplet to a second chiplet, the first TLP comprising first data and a first sequence number associated with the first data; and
means for sending a second TLP from the second chiplet to the first chiplet, the second TLP comprises:
the first sequence number and first acknowledgement information corresponding to the first data; and
selective second data generated by the second chiplet.

20. The SoC of claim 19, further comprising:
means for determining that the first data is successfully transmitted in response to the first acknowledgement information being an acknowledgement (ACK) of the first data; and
means for determining that the first data is not successfully transmitted in response to the first acknowledgement information being a negative acknowledgement (NACK) of the first data.
